(19) United States
(12) Patent Application Publication
(10) Pub. No.: US 2023/0196731 A1
(43) Pub. Date: Jun. 22, 2023

(54) SYSTEM AND METHOD FOR TWO-STAGE OBJECT DETECTION AND CLASSIFICATION

(71) Applicant: GM CRUISE HOLDINGS LLC, San Francisco, CA (US)

(72) Inventors: Pranay Agrawal, San Francisco, CA (US); Cheng-An Hou, San Ramon, CA (US); Debanjan Nandi, Fremont, CA (US)

(21) Appl. No.: 17/556,662

(22) Filed: Dec. 20, 2021

(51) Int. Cl. G06V 10/77; G06V 10/80; G06T 7/73

(52) U.S. Cl. CPC G06V 10/7715; G06V 10/803; G06T 7/73; G06T 2210/12; G06T 2207/30252; G06T 2207/10028; G06V 2201/07

(57) ABSTRACT

The disclosed technology provides solutions for object detection and classification with both high recall and high precision, by using a first stage with high recall, and a second stage to provide high precision. The dimensional state of a pointcloud is reduced from 3 to 2, and proposed bounding boxes are generated. The original pointcloud data is filtered according to the bounding boxes, and fused with learned features, with the fused data processed to generate the high recall and high precision output.

### BACKGROUND

### 1. Technical Field

The disclosed technology provides solutions for improving models used for object detection and identification in autonomous vehicles (AVs) and in particular, for accurately detecting and classifying objects within a computing and latency budget.

### 2. Introduction

Autonomous vehicles (AVs) are vehicles having computers and control systems that perform driving and navigation tasks that are conventionally performed by a human driver. As AV technologies continue to advance, they will be increasingly used to improve transportation efficiency and safety. As such, AVs will need to perform many of the functions that are conventionally performed by human drivers, such as performing navigation and routing tasks necessary to provide a safe and efficient transportation. Such tasks may require the collection and processing of large quantities of data using various sensor types, including but not limited to cameras and/or Light Detection and Ranging (LiDAR) sensors disposed on the AV. In some instances, the collected data can be used by the AV to perform tasks relating to routing, planning and obstacle avoidance.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 illustrates a functional diagram of a two-stage process for two data sources.

FIG. 2A illustrates a functional diagram of a two-stage process for a single data source.

FIG. 2B illustrates a functional diagram of a two-stage process for a single data source.

FIG. 3 illustrates a flow diagram of an example process for object detection in a two-stage process.

FIG. 4 illustrates an example system for managing one or more Autonomous Vehicles (AVs), according to some aspects of the disclosed technology.

FIG. 5 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Perception systems of autonomous vehicles are designed to detect various objects in the surrounding environment in order to execute effective navigation and planning operations. These perception systems operate on data captured by environmental sensors on the AV, such as camera, LiDAR, and/or radar. Although technology has advanced to the point that an AV can carry a very powerful processing engine, there are still significant restrictions on how much of that processing power is available for the vast and disparate functions that must be performed by the AV. In addition, because the AV is moving, and must identify possible hazards to make timely decisions and avoid those hazards, there are strict latency requirements.

Balanced with the computing and latency budgets that are available to the AV, the detection models strive for both high precision and high recall in the effort to detect and classify the objects in a scene. Precision is generally understood to represent the fraction of relevant instances among the retrieved instances. Recall is generally understood to represent the fraction of relevant instances that were retrieved.

As an example, if there are 100 total relevant objects that might be detected, and a machine learning algorithm returns 30 detected objects, with 20 of the 30 detected objects being relevant, and 10 of the 30 detected objects being irrelevant, we can say that the precision is 20/100 or 20%. The fraction of relevant instances that were retrieved (recall) is 20/30, or 66%.

For the AV, it is desirable to have both high precision and high recall, but this can be difficult when the model must process the full image scene. In one aspect it can be helpful to apply a two-stage detector, which provides a coarse detection on the full image scene in the first stage, and then a fine detection to refine object detection in the second stage. In one arrangement, the first stage may operate on data from a single environmental sensor, such as only LiDAR data, or only camera image data. In another arrangement, the first stage may operate on data from a single environmental sensor to generate proposal boxes, and then the second stage may add data from a second environmental sensor. The second stage model is different from the first stage model, and uses information from both environmental sensors, while also using learned features from the first stage to augment detection in the second stage.

The first stage processes the full image scene, and does high recall detection creating object proposals. However, the output from the first stage may be low precision. The second stage consumes the object proposals from the first stage along with raw sensor data in a more feature-rich model. This leads to both high precision and high recall detections with precise bounding box geometry. This approach also allows fusion of different sensor modalities for both bounding box proposal generation and feature extraction.

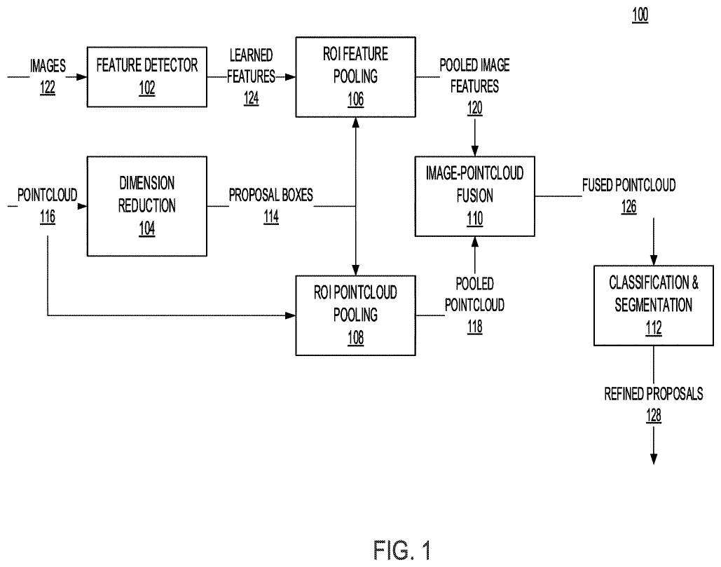

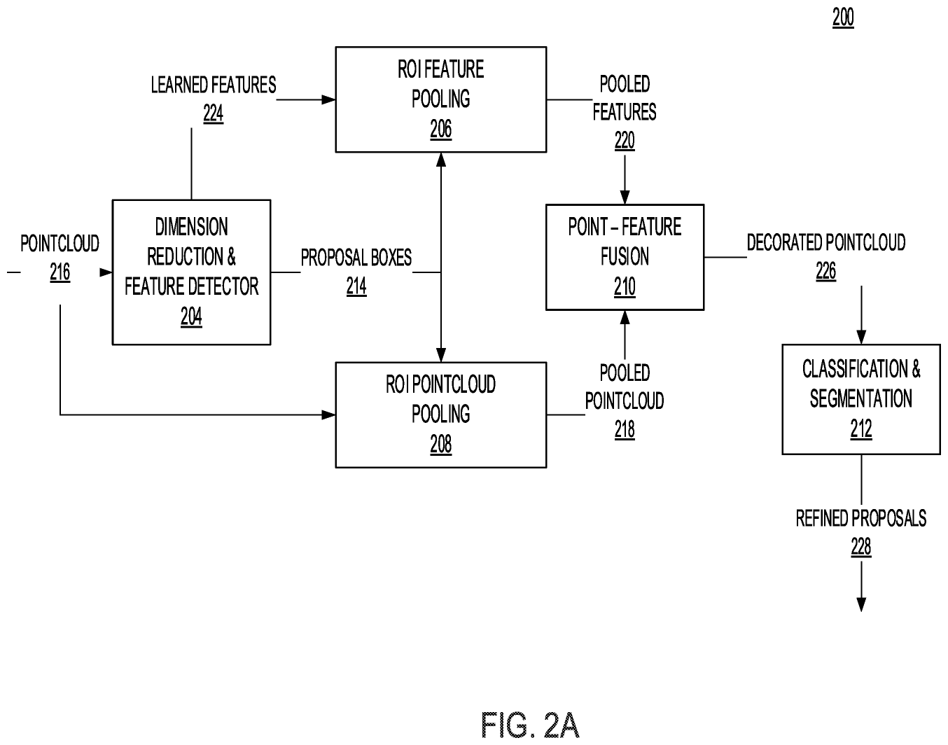

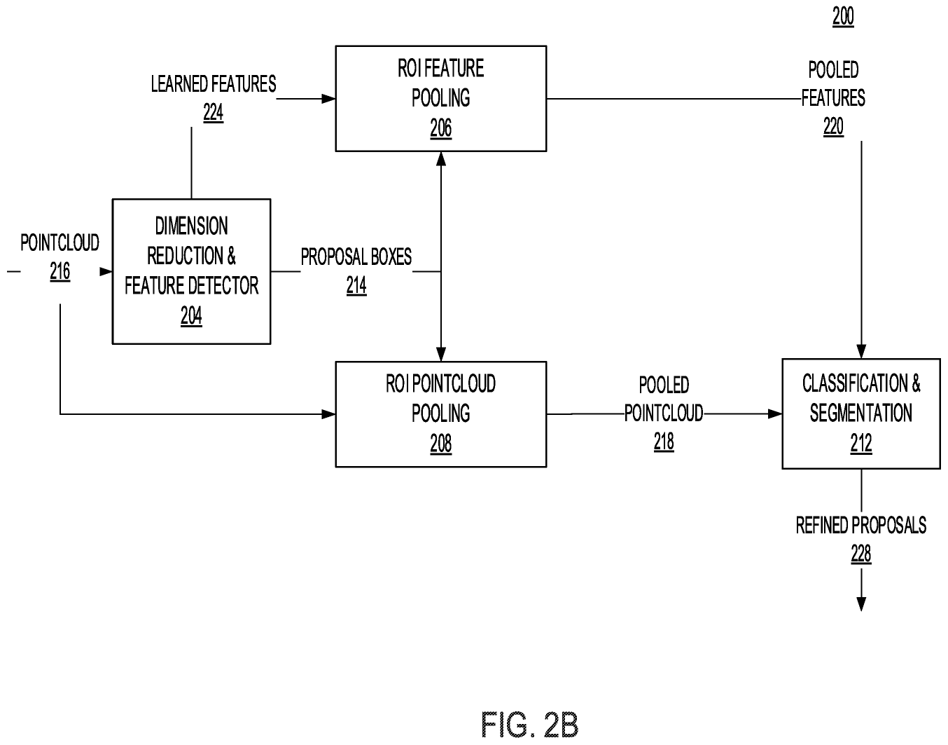

FIG. 1 illustrates a functional block diagram for such a two-stage process, where two different data sources are used. Similar two-stage processes are illustrated in FIGS. 2A/2B and described below using a single data source. At 104 of process 100, the dimension of a pointcloud 116, which represents data in three dimensions, as collected from all or a substantial portion of an entire scene, is reduced. This dimension reduction may be from three dimensions to two dimensions. In one version, the pointcloud is generated from a LiDAR sensor. This reduction in dimension at 104 can take various forms, including generating a bird's eye view or top down view. At 104 of process 100, the two-dimensional data is also organized and proposed bounding boxes 114 are one output of 104. The dimension reduction and generation of proposed bounding boxes at 104 can be performed by various means. In one version, the use of PointPillars, which is an open source code base, is an example of the dimension reduction process at 104. The process at 104 may be generically referred to as a pillar detector, and is a representation of the pointcloud organized into vertical columns (pillars). The proposed bounding boxes 114, which are an output of 104, represent the end of a first stage, and that output is high recall, but it is generally not high precision.

The proposed bounding boxes 114 are used at region of interest (ROI) feature pooling 106, and also at ROI pointcloud pooling 108. At ROI pointcloud pooling 108, the pointcloud data 116 that corresponds to areas within the proposed bounding boxes is saved, and the rest of the raw pointcloud data is ignored. The output of ROI pointcloud pooling 108 of process 100 is pooled pointcloud data 118.

In a parallel path, image data 122, which represents image data captured from part or the full scene, is processed by feature detector 102, to generate learned features 124. The learned features 124 are generally multi-dimensional vectors that represent features in the image data. The values of the multi-dimensional vectors have meaning to the system, but they usually have no apparent meaning to a human. In one version, the feature detector 102 is a fully convolutional one-stage (FCOS) object detector. There is at least one open source code base known as FCOS that is an example of feature detector 102.

At ROI feature pooling 106 of process 100, the learned features 124 from feature detector 102 that correspond to areas within the proposed bounding boxes are saved, and the rest of the learned features 124 are ignored. This produces pooled image features 120. The pooled image features at 120, and the pooled pointcloud at 118 represent respective learned features and pointcloud data that are located within the proposed bounding boxes 114. By ignoring learned features and pointcloud data that is outside the proposed bounding boxes 114, there is a reduction in the amount of image and pointcloud data that must be processed to refine object detection.

At 110 of process 100, the pooled image features 120, and the pooled pointcloud 118 are fused. This can be a concatenation of the information, and the output is a fused pointcloud 126. The fused pointcloud 126 can also be referred to as a decorated pointcloud. The fused pointcloud 126 includes both learned feature and pointcloud information.

The fused or decorated pointcloud 126 is processed by classification and segmentation 112 of process 100, to produce refined proposals 128. In one example, classification and segmentation 112 of process 100 is PointNet, which is an open source code base.

Similar to the process described above with reference to FIG. 1, FIGS. 2A/2B illustrate a similar process using a single data source. At 204 of process 200, the dimension of a pointcloud 216, which represents data in three dimensions, as collected from all or a substantial portion of an entire scene, is reduced. This dimension reduction may be from three dimensions to two dimensions. In one version, the pointcloud is generated from a LiDAR sensor. This reduction in dimension at 204 can take various forms, including generating a bird's eye view or top down view. At 204 of process 200, the two-dimensional data is also organized and proposed bounding boxes 214 are one output of 204.

At 204 of process 204, learned features 224 are also detected. The learned features 224 are generally multi-dimensional vectors that represents features of the objects represented in the pointcloud data. The values of the multi-dimensional vectors have meaning to the system, but they usually have no apparent meaning to a human.

The dimension reduction, generation of learned features, and generation of proposed bounding boxes at 204 can be performed by various means. In one version, the use of PointPillars, which is an open source code base, is an example of the dimension reduction process at 204. The process at 204 may be generically referred to as a pillar detector, and is a representation of the pointcloud organized into vertical columns (pillars). The proposed bounding boxes 214, which are an output of dimension reduction and feature detector 204, represent the end of a first stage, and that output is high recall, but it is generally not high precision.

The proposed bounding boxes 214 are used at region of interest (ROI) feature pooling 206, and also at ROI pointcloud pooling 208. At ROI pointcloud pooling 208, the pointcloud data 216 that corresponds to areas within the proposed bounding boxes is saved, and the rest of the raw pointcloud data is ignored. The output of ROI pointcloud pooling 208 of process 200 is pooled pointcloud data 218.

At ROI feature pooling 206 of process 200, the learned features 224 from dimension reduction and feature detector 204 that correspond to areas within the proposed bounding boxes are saved, and the rest of the learned features 224 are ignored. This produces pooled features 220. The pooled features 220, and the pooled pointcloud 218 represent respective learned features and pointcloud data that are located within the proposed bounding boxes 214. By ignoring learned features and pointcloud data that is outside the proposed bounding boxes 214, there is a reduction in the amount of image and pointcloud data that must be processed to refine object detection.

As illustrated in FIG. 2A, at 210 of process 200, the pooled features 220, and the pooled pointcloud 218 are fused. This can be a concatenation of the information, and the output is a fused or decorated pointcloud 226. The fused or decorated pointcloud 226 includes both feature and pointcloud information. The fused or decorated pointcloud 226 is processed by classification and segmentation 212 of process 200, to produce refined proposals 228. In one example, classification and segmentation 212 of process 200 is PointNet, which is an open source code base.

In a slightly different example illustrated in FIG. 2B, the pooled features 220, and the pooled pointcloud 218 are both provided to classification and segmentation 212 of process 200, to produce refined proposals 228. In one example, classification and segmentation 212 of process 200 is PointNet, which is an open source code base.

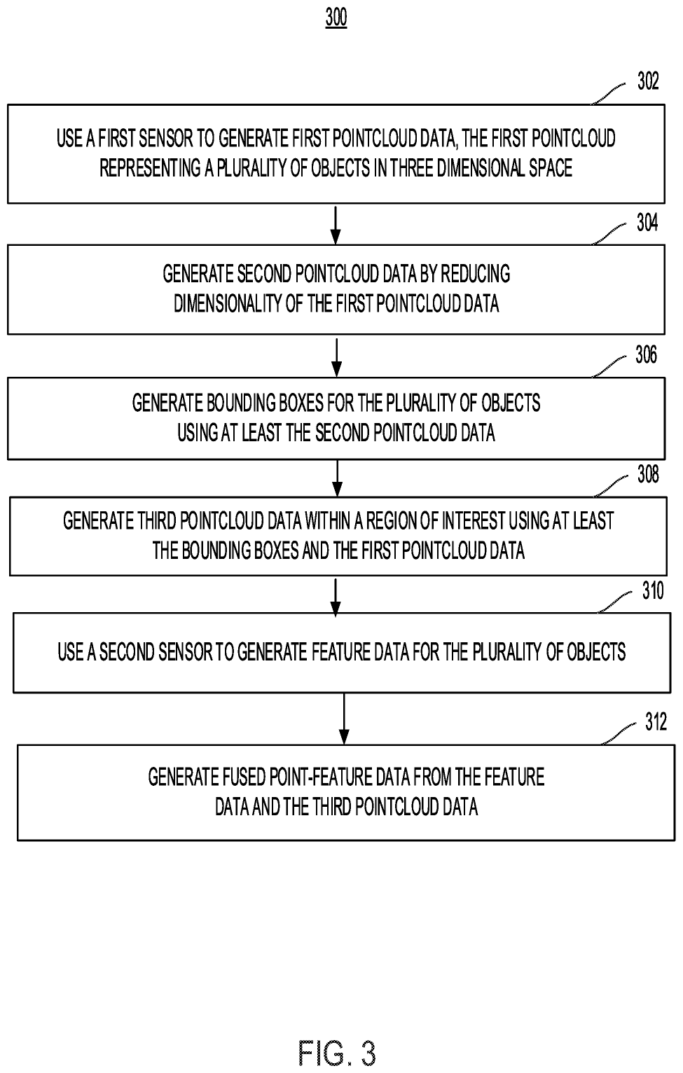

FIG. 3 illustrates a flow diagram of an example process 300, according to some aspects of the disclosed technology. At step 302, the process 300 includes generating first pointcloud data using a first sensor. The first pointcloud represents a plurality of objects in three-dimensional space. In one example, the first sensor is a LiDAR sensor.

At step 304, the process 300 includes generating second pointcloud data by reducing the dimensionality of the first pointcloud data. In one example, PointPillar is used at step 304 to reduce dimensionality of 3-D LiDAR data to produce a top-down or bird's-eye view 2D pointcloud.

At step 306, the process 300 includes generating bounding boxes for the plurality of objects using the second pointcloud data. In one example, PointPillar is used at step 306 to generate the proposed bounding boxes.

At step 308, the process 300 includes generating third pointcloud data within a region of interest using at least the proposed bounding boxes generated at step 304, and the first pointcloud data.

At step 310, the process 300 includes using a second sensor to generate feature data for a plurality of objects. In one example, an FCOS backbone is used to generate the feature data. The feature data can also be referred to as learned features. The feature data may be a multi-dimensional vector that represents the learned features.

At step 312, the process 300 includes generating fused point-feature data from the feature data and the third pointcloud data.

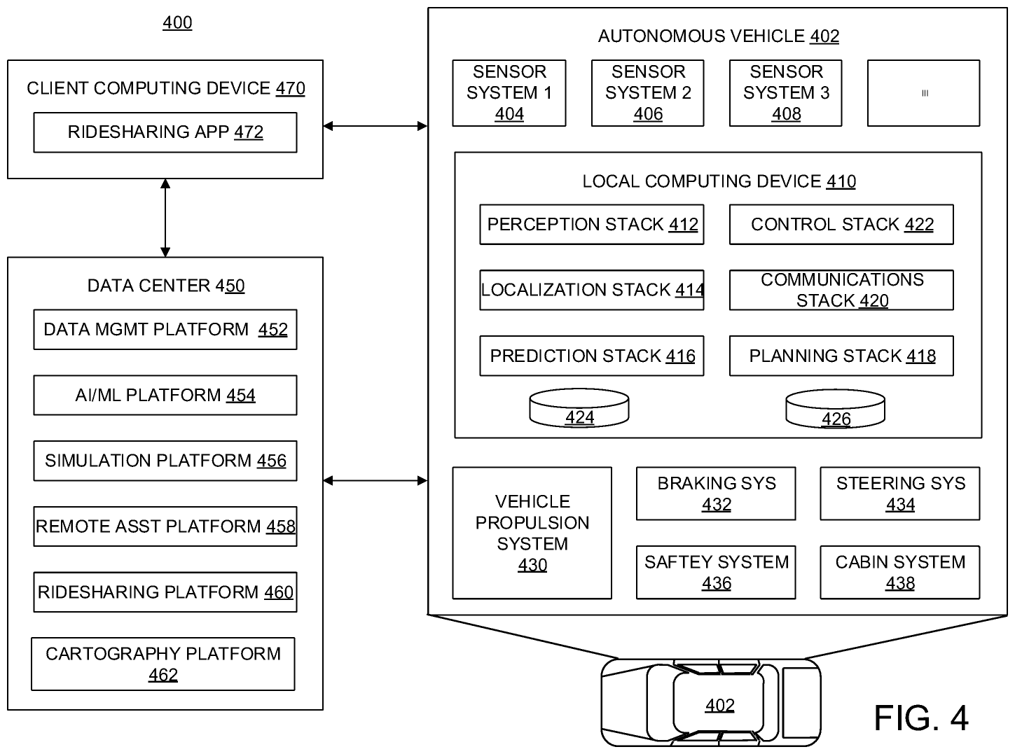

FIG. 4 illustrates an example of an AV management system 400. Processes 100, 200, and 300 described above are generally performed by perception stack 412 described below. However, processes 100, 200 and 300 can be performed by other components of system 400. One of ordinary skill in the art will understand that, for the AV management system 400 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 400 includes an AV 402, a data center 450, and a client computing device 470. The AV 402, the data center 450, and the client computing device 470 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 402 can navigate roadways without a human driver based on sensor signals generated by multiple sensor systems 404, 406, and 408. The sensor systems 404-408 can include different types of sensors and can be arranged about the AV 402. For instance, the sensor systems 404-408 can comprise Inertial Measurement Units (IMUs), cameras (e.g., still image cameras, video cameras, etc.), light sensors (e.g., LiDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 404 can be a camera system, the sensor system 406 can be a LiDAR system, and the sensor system 408 can be a RADAR system. Other embodiments may include any other number and type of sensors.

The AV 402 can also include several mechanical systems that can be used to maneuver or operate the AV 402. For instance, the mechanical systems can include a vehicle propulsion system 430, a braking system 432, a steering system 434, a safety system 436, and a cabin system 438, among other systems. The vehicle propulsion system 430 can include an electric motor, an internal combustion engine, or both. The braking system 432 can include an engine brake, brake pads, actuators, and/or any other suitable componentry configured to assist in decelerating the AV 402. The steering system 434 can include suitable componentry configured to control the direction of movement of the AV 402 during navigation. The safety system 436 can include lights and signal indicators, a parking brake, airbags, and so forth. The cabin system 438 can include cabin temperature control systems, in-cabin entertainment systems, and so forth. In some embodiments, the AV 402 might not include human driver actuators (e.g., steering wheel, handbrake, foot brake pedal, foot accelerator pedal, turn signal lever, window wipers, etc.) for controlling the AV 402. Instead, the cabin system 438 can include one or more client interfaces (e.g., Graphical User Interfaces (GUIs), Voice User Interfaces (VUIs), etc.) for controlling certain aspects of the mechanical systems 430-438.

The AV 402 can additionally include a local computing device 410 that is in communication with the sensor systems 404-408, the mechanical systems 430-438, the data center 450, and the client computing device 470, among other systems. The local computing device 410 can include one or more processors and memory, including instructions that can be executed by the one or more processors. The instructions can make up one or more software stacks or components responsible for controlling the AV 402; communicating with the data center 450, the client computing device 470, and other systems; receiving inputs from riders, passengers, and other entities within the AV's environment; logging metrics collected by the sensor systems 404-408; and so forth. In this example, the local computing device 410 includes a perception stack 412, a mapping and localization stack 414, a prediction stack 416, a planning stack 418, a communications stack 420, a control stack 422, an AV operational database 424, and an HD geospatial database 426, among other stacks and systems.

The perception stack 412 can enable the AV 402 to “see” (e.g., via cameras, LiDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 404-408, the mapping and localization stack 414, the HD geospatial database 426, other components of the AV, and other data sources (e.g., the data center 450, the client computing device 470, third party data sources, etc.). The perception stack 412 can detect and classify objects and determine their current locations, speeds, directions, and the like. In addition, the perception stack 412 can determine the free space around the AV 402 (e.g., to maintain a safe distance from other objects, change lanes, park the AV, etc.). The perception stack 412 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 414 can determine the AV's position and orientation (pose) using different methods from multiple systems (e.g., GPS, IMUs, cameras, LiDAR, RADAR, ultrasonic sensors, the HD geospatial database 426, etc.). For example, in some embodiments, the AV 402 can compare sensor data captured in real-time by the sensor systems 404-408 to data in the HD geospatial database 426 to determine its precise (e.g., accurate to the order of a few centimeters or less) position and orientation. The AV 402 can focus its search based on sensor data from one or more first sensor systems (e.g., GPS) by matching sensor data from one or more second sensor systems (e.g., LiDAR). If the mapping and localization information from one system is unavailable, the AV 402 can use mapping and localization information from a redundant system and/or from remote data sources.

The prediction stack 416 can receive information from the localization stack 414 and objects identified by the perception stack 412 and predict a future path for the objects. In some embodiments, the prediction stack 416 can output several likely paths that an object is predicted to take along with a probability associated with each path. For each predicted path, the prediction stack 416 can also output a range of points along the path corresponding to a predicted location of the object along the path at future time intervals along with an expected error value for each of the points that indicates a probabilistic deviation from that point.

The planning stack 418 can determine how to maneuver or operate the AV 402 safely and efficiently in its environment. For example, the planning stack 418 can receive the location, speed, and direction of the AV 402, geospatial data, data regarding objects sharing the road with the AV 402 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 402 from one point to another and outputs from the perception stack 412, localization stack 414, and prediction stack 416. The planning stack 418 can determine multiple sets of one or more mechanical operations that the AV 402 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 418 can select from multiple backup plans to carry out. For example, while preparing to change lanes to turn right at an intersection, another vehicle may aggressively cut into the destination lane, making the lane change unsafe. The planning stack 418 could have already determined an alternative plan for such an event. Upon its occurrence, it could help direct the AV 402 to go around the block instead of blocking a current lane while waiting for an opening to change lanes.

The control stack 422 can manage the operation of the vehicle propulsion system 430, the braking system 432, the steering system 434, the safety system 436, and the cabin system 438. The control stack 422 can receive sensor signals from the sensor systems 404-408 as well as communicate with other stacks or components of the local computing device 410 or a remote system (e.g., the data center 450) to effectuate operation of the AV 402. For example, the control stack 422 can implement the final path or actions from the multiple paths or actions provided by the planning stack 418. This can involve turning the routes and decisions from the planning stack 418 into commands for the actuators that control the AV's steering, throttle, brake, and drive unit.

The communication stack 420 can transmit and receive signals between the various stacks and other components of the AV 402 and between the AV 402, the data center 450, the client computing device 470, and other remote systems. The communication stack 420 can enable the local computing device 410 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 420 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 426 can store HD maps and related data of the streets upon which the AV 402 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 424 can store raw AV data generated by the sensor systems 404-408, stacks 412-422, and other components of the AV 402 and/or data received by the AV 402 from remote systems (e.g., the data center 450, the client computing device 470, etc.). In some embodiments, the raw AV data can include HD LiDAR pointcloud data, image data, RADAR data, GPS data, and other sensor data that the data center 450 can use for creating or updating AV geospatial data or for creating simulations of situations encountered by AV 402 for future testing or training of various machine learning algorithms that are incorporated in the local computing device 410.

The data center 450 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 450 can include one or more computing devices remote to the local computing device 410 for managing a fleet of AVs and AV-related services. For example, in addition to managing the AV 402, the data center 450 may also support a ridesharing service, a delivery service, a remote/roadside assistance service, street services (e.g., street mapping, street patrol, street cleaning, street metering, parking reservation, etc.), and the like.

The data center 450 can send and receive various signals to and from the AV 402 and the client computing device 470. These signals can include sensor data captured by the sensor systems 404-408, roadside assistance requests, software updates, ridesharing pick-up and drop-off instructions, and so forth. In this example, the data center 450 includes a data management platform 452, an Artificial Intelligence/Machine Learning (AI/ML) platform 454, a simulation platform 456, a remote assistance platform 458, and a ridesharing platform 460, among other systems.

The data management platform 452 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 450 can access data stored by the data management platform 452 to provide their respective services.

The AI/ML platform 454 can provide the infrastructure for training and evaluating machine learning algorithms for operating the AV 402, the simulation platform 456, the remote assistance platform 458, the ridesharing platform 460, the cartography platform 462, and other platforms and systems. Using the AI/ML platform 454, data scientists can prepare data sets from the data management platform 452; select, design, and train machine learning models; evaluate, refine, and deploy the models; maintain, monitor, and retrain the models; and so on.

The simulation platform 456 can enable testing and validation of the algorithms, machine learning models, neural networks, and other development efforts for the AV 402, the remote assistance platform 458, the ridesharing platform 460, the cartography platform 462, and other platforms and systems. The simulation platform 456 can replicate a variety of driving environments and/or reproduce real-world scenarios from data captured by the AV 402, including rendering geospatial information and road infrastructure (e.g., streets, lanes, crosswalks, traffic lights, stop signs, etc.) obtained from the cartography platform 462; modeling the behavior of other vehicles, bicycles, pedestrians, and other dynamic elements; simulating inclement weather conditions, different traffic scenarios; and so on.

The remote assistance platform 458 can generate and transmit instructions regarding the operation of the AV 402. For example, in response to an output of the AI/ML platform 454 or other system of the data center 450, the remote assistance platform 458 can prepare instructions for one or more stacks or other components of the AV 402.

The ridesharing platform 460 can interact with a customer of a ridesharing service via a ridesharing application 472 executing on the client computing device 470. The client computing device 470 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing the ridesharing application 472. The client computing device 470 can be a customer's mobile computing device or a computing device integrated with the AV 402 (e.g., the local computing device 410). The ridesharing platform 460 can receive requests to pick up or drop off from the ridesharing application 472 and dispatch the AV 402 for the trip.

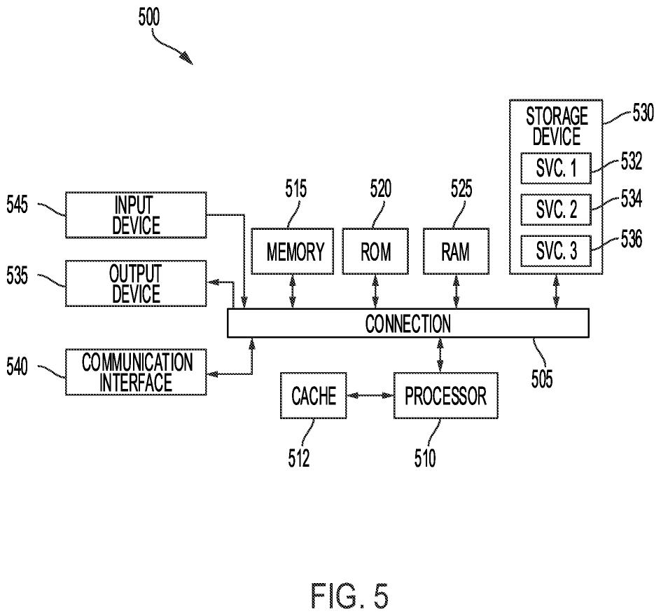

FIG. 5 illustrates an example processor-based system with which some aspects of the subject technology can be implemented. For example, processor-based system 500 can be any computing device making up local computing system 410, client computing device 470, a passenger device executing the rideshare app 472, data center 450, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 500 includes at least one processing unit (CPU or processor) 510 and connection 505 that couples various system components including system memory 515, such as read-only memory (ROM) 520 and random-access memory (RAM) 525 to processor 510. Computing system 500 can include a cache of high-speed memory 512 connected directly with, in close proximity to, or integrated as part of processor 510.

Processor 510 can include any general-purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communication interface 540 may also include one or more Global Navigation Satellite System (GNSS) receivers or transceivers that are used to determine a location of the computing system 500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

Storage device 530 can include software services, servers, services, etc., that when the code that defines such software is executed by the processor 510, it causes the system to perform a function. In some embodiments, a hardware service that performs a particular function can include the software component stored in a computer-readable medium in connection with the necessary hardware components, such as processor 510, connection 505, output device 535, etc., to carry out the function.

As understood by those of skill in the art, machine-learning based classification techniques can vary depending on the desired implementation. For example, machine-learning classification schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. An autonomous vehicle, comprising:
one or more environmental sensors;
at least one memory; and
at least one processor coupled to the at least one memory and the one or more environmental sensors, the at least one processor configured to:
use a first environmental sensor to generating first pointcloud data, the first pointcloud data representing a plurality of objects in three dimensional space;
generate second pointcloud data by reducing dimensionality of the first pointcloud data;
generate bounding boxes for the plurality of objects using at least the second pointcloud data;
generate third pointcloud data within a region of interest using at least the bounding boxes and the first pointcloud data;
use a second environmental sensor to generate feature data for the plurality of objects; and
generate fused point-feature data from the feature data and the third pointcloud data.

2. The autonomous vehicle of claim 1, wherein the at least one processor is further configured to use a pillar detector to reduce dimensionality of the first pointcloud data.

3. The autonomous vehicle of claim 1, wherein the at least one processor is further configured to use region of interest pointcloud pooling to generate the third pointcloud data.

4. The autonomous vehicle of claim 1, wherein the at least one processor is further configured to use pointnet to process the fused point-feature data and generate refined data.

5. The autonomous vehicle of claim 1, wherein the at least one processor is further configured to use a fully convolutional one-state object detection backbone to process image data from the second sensor and generate the feature data.

6. The autonomous vehicle of claim 1, wherein the first environmental sensor is a LiDAR detector.

7. The autonomous vehicle of claim 1, wherein the second environmental sensor is an optical camera.

8. A computer-implemented method, comprising:
using a first sensor to generating first pointcloud data, the first pointcloud data representing a plurality of objects in three dimensional space;
generating second pointcloud data by reducing dimensionality of the first pointcloud data;
generating bounding boxes for the plurality of objects using at least the second pointcloud data;
generating third pointcloud data within a region of interest using at least the bounding boxes and the first pointcloud data;
using a second sensor to generate feature data for the plurality of objects; and
generating fused point-feature data from the feature data and the third pointcloud data.

9. The computer-implemented method of claim 8, further comprising using a pillar detector to reduce dimensionality of the first pointcloud data.

10. The computer-implemented method of claim 8, further comprising using region of interest pointcloud pooling to generate the third pointcloud data.

11. The computer-implemented method of claim 8, further comprising using pointnet to process the fused point-feature data and generate refined data.

12. The computer-implemented method of claim 8, further comprising using a fully convolutional one-state object detection backbone to process image data from the second sensor and generate the feature data.

13. The computer-implemented method of claim 8, wherein the first sensor is a LiDAR detector.

14. The computer-implemented method of claim 8, wherein the second sensor is an optical camera.

15. A non-transitory computer-readable storage medium comprising at least one instruction for causing a computer or processor to:
use a first sensor to generating first pointcloud data, the first pointcloud data representing a plurality of objects in three dimensional space;
generate second pointcloud data by reducing dimensionality of the first pointcloud data;
generate bounding boxes for the plurality of objects using at least the second pointcloud data;
generate third pointcloud data within a region of interest using at least the bounding boxes and the first pointcloud data;
use a second sensor to generate feature data for the plurality of objects; and
generate fused point-feature data from the feature data and the third pointcloud data.

16. The non-transitory computer-readable storage medium of claim 15, wherein the at least one instruction is further configured to use a pillar detector to reduce dimensionality of the first pointcloud data.

17. The non-transitory computer-readable storage medium of claim 15, wherein the at least one instruction is further configured to use region of interest pointcloud pooling to generate the third pointcloud data.

18. The non-transitory computer-readable storage medium of claim 15, wherein the at least one instruction is further configured to use pointnet to process the fused point-feature data and generate refined data.

19. The non-transitory computer-readable storage medium of claim 15, wherein the at least one instruction is further configured to use a fully convolutional one-state object detection backbone to process image data from the second sensor and generate the feature data.

20. The non-transitory computer-readable storage medium of claim 15, wherein the first sensor is a LiDAR detector.
